(19) United States
(12) Patent Application Publication
(10) Pub. No.: US 2006/0066525 A1
(43) Pub. Date: Mar. 30, 2006

(54) Colour control for active matrix electroluminescent display

(75) Inventor: Mark J. Childs, SUTTON (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/535,324

(22) PCT Filed: Nov. 11, 2003
(86) PCT No.: PCT/IB03/05105

§ 371 Date: May 18, 2005

(30) Foreign Application Priority Data
Nov. 23, 2002 (GB) 0227356.3

(51) Int. Cl. G09G 3/30

(52) U.S. Cl. 345/76

(57) ABSTRACT

A colour active matrix EL display device has a row and column array of colour pixels (1) which each comprise an electroluminescent display element (2) connected in series with a drive transistor (22) to a power line (26). The different colour pixels in a row are connected to respective and separate power lines (26, 26″, 26″′). The respective power supplies to each of the separate power lines associated with a row of pixels is individually switchable (45,48) to enable control of the duty cycles of the differently coloured pixels in the row. In this way, different efficiencies of different colour EL material used in the display elements can be accommodated and and adjustment of the relative brightness of each colour can be achieved.

This invention relates to colour active matrix electroluminescent display devices, for example active matrix display devices using organic electroluminescent elements such as polymer LEDs.

Matrix display devices employing electroluminescent, light-emitting, display elements are well known. The display elements may comprise organic thin film electroluminescent elements, for example using polymer materials, or else light emitting diodes (LEDs) using traditional III-V semiconductor compounds. Recent developments in organic electroluminescent materials, particularly polymeter materials, have demonstrated their ability to be used practically for video displaying devices. These materials typically comprise one or more layers of a semiconducting conjugated polymeter sandwiched between a pair of electrodes, one of which is transparent and the other of which is of a material suitable for injecting holes or electrons into polymer layer.

The polymer material can be fabricated using a PVD process, or simply by a spin coating technique using a solution of a soluble conjugated polymer. Ink-jet printing may also be used. Organic electroluminescent materials exhibit diode-like I-V properties, so that they are capable of providing both a display function and a switching function, and can therefore be used in passive type displays. Alternatively, these materials may be used for active matrix display devices, with each pixel comprising a display element and a switching device for controlling the current through the display element.

Display devices of this type have current-addressed display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

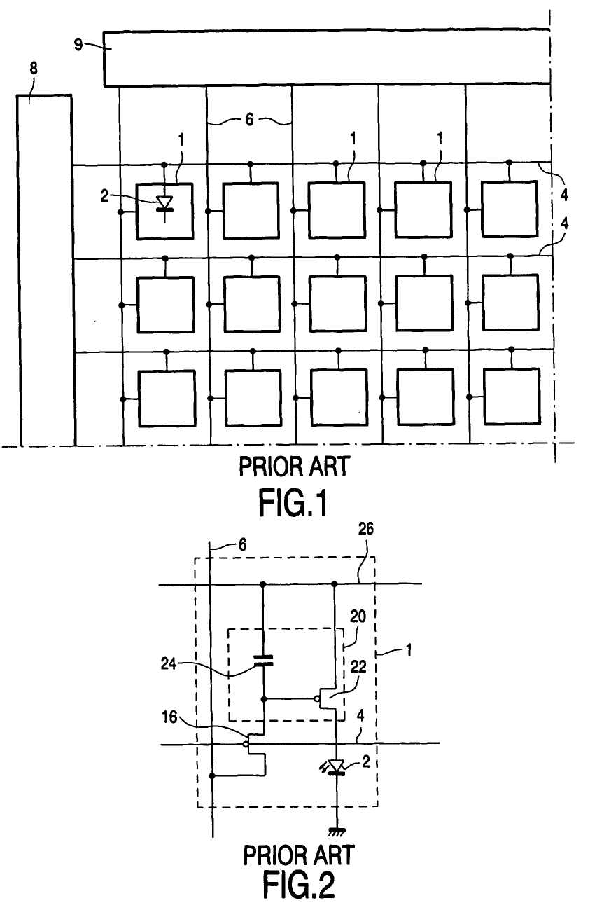

FIG. 1 shows a known active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. In practice there may be several hundred or more rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. For downward emitting arrangements, the support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support. Typical examples of suitable organic electroluminescent materials which can be used for the elements 2 are known and described in EP-A-0 717446. Conjugated polymer materials as described in WO96/36959 can also be used.

FIG. 2 shows in simplified schematic form a known pixel and drive circuitry arrangement for providing voltage-addressed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended. The drive transistor 22 draws a current from the power supply line 26 which is common to all pixels in the same row and this current passing through the EL display element 1 causes light to be generated by the element. The brightness of the light emission is proportional to the peak current, and therefore dependent on the value of the applied column voltage (data signal).

The drive transistor 22 in this circuit is implemented as a PMOS-TFT, so that the storage capacitor 24 holds the gate-source voltage fixed. This results in a fixed source-drain current through the transistor, which therefore provides the desired current source operation of the pixel.

The above basic pixel circuit is a voltage-addressed pixel, and there are also current-addressed pixels which sample a drive current. However, all pixel configurations require current to be supplied to each pixel.

In colour display devices, each row of pixels comprises pixels generating light outputs of different colours, typically red, green and blue. The different colours may be generated by using white light emitting electroluminescent (EL) display elements together with respective colour filter elements. Preferably, however, the different colour light outputs are obtained using different EL materials for the red, green and blue EL display elements as this is usually a more efficient approach.

A problem with such colour display devices is that generally the voltage and currents required to be applied to the EL display elements to produce similar amounts of light (i.e. brightness levels) from each pixel can vary significantly. This is partially a function of the response of the eye, which is more sensitive to green light than blue or red light, and also the fact that the different EL materials used for different colour pixels often have different efficiencies of light production. As a typical example using presently available polymer LED materials, the red pixels may require several times the current and voltage of the green pixels to produce a balanced white colour. In normal driving schemes, the driving circuit for the pixel array preferably should be able to drive all the pixels and the voltage of the line supplying power to the pixels must be sufficient to drive adequately the least efficiency colour pixels. However, this can lead to the most efficient colour EL elements being driven by a power line operating at a relatively high voltage with the result that the driving circuit will dissipate far more power than required.

The drive currents provided by the drive transistors for the different colour EL elements could be regulated to account for the different efficiencies of light production by appropriately scaling their channel dimensions but this would lead to different problems, for example, more complicated fabrication and different pixel aperture characteristics for the different colour pixels.

According to the present invention there is provided a colour active matrix electroluminescent display device comprising a row and column array of display pixels, each pixel comprising an electroluminescent display element and a drive transistor for driving a current through the display element, the drive transistor and the display element being connected in series between a power line for supplying or drawing a controllable current to or from the display element and a common potential line, wherein each row of display pixels comprises different colour display pixels for producing different colour light outputs, wherein the display pixels of each colour in a row are associated with a respective and separate power line, and wherein the power supply to each power line is individually switchable so as to control the duty cycle of the associated display pixels.

The ability to control the duty cycle, that is, the ratio of the time a pixel emits light to the time it does not emit light in one frame period or scanning cycle, of the different colour display pixels using separate power lines in this manner avoids the aforementioned kind of problems and also offers further advantages. If the EL display element of a pixel is energised to produce light output for only a fraction of the possible frame period rather than substantially the entire frame period as is normally the case, then the apparent brightness of the display element to a viewer will be reduced. The variation of the duration of light emission corresponds to a variation in the peak current of an LED element. A display element energised at a brightness level Y for I/X of the frame period will appear to have on average brightness in time of Y/X. Thus, in the case of different colour display pixels whose EL display elements are of different efficiencies it becomes possible through the individual duty cycle control to energise the lower efficiency EL display element for example for substantially the entire frame period to keep the current it consumes low and to energise the higher efficiency EL element for only a relatively short proportion of the frame period to increase the current it consumes so as to be of the same order as that of the lower efficiency element. In this respect, it is preferable from driving circuitry considerations for the driving currents for different colour pixels to be equalised as far as possible. Moreover, by allowing the duty cycle of each of the different colours of display pixels to be controlled individually by controlling power supply to their respective power supply lines, adjustment of the relative brightness of each colour is easily achieved.

It will be appreciated that the ability to control individually the brightness of the different colours and the brightness of the whole display (image) output without necessarily affecting the colour depth and gamma is of considerable benefit.

Because the current for the pixels of a row is carried by a plurality of power lines, each power line can be of reduced width or thickness compared with that of a single power line used for all pixels in the row.

In a preferred embodiment, each row of pixels comprises red, green and blue display pixels and is provided with three power lines connected respectively to the red, green and blue display pixels. The pixels of the array can be programmed in conventional manner in respective row address (line) periods. They may be voltage programmed, with a voltage data signal applied to the column conductors and with the drive TFT's gate voltage determined thereby being held on the storage capacitor, or current programmed by sampling a drive current, for example using a current mirror in each pixel circuit, for example as described in U.S. Pat. No. 6,359,605 whose disclosure is incorporated herein by reference. In the former case, the power to the power lines of a row are turned off while the display pixels of the row are being addressed and programmed in the row address period and thereafter turned on in order to energise the EL elements. Consequently, the need to provide in each pixel an additional TFT operable to isolate the EL element from the power line during the addressing period, which is sometimes necessary in order to compensate for the effects voltage drops which can occur along the power line altering the desired programme state, is then avoided.

The power lines associated with rows of display pixels are preferably connected at one side of the array to respective power rails through respective switches of a switching arrangement, the power rails being shared by the power lines of all rows of display pixels. Preferably, the switching arrangement is operable row sequentially so as to connect each power line of one pixel row to its respective power rail for a time appropriate to the desired duty cycle for the display pixels associated with that power line. Timed operation of the switching arrangement in this manner may be achieved, for example, using a shift register type circuit.

An embodiment of the invention will now be described, by way of example, with reference to the accompanying drawings, in which:

FIG. 1 shows schematically a known active matrix EL display device;

FIG. 2 is a simplified schematic diagram of a known pixel circuit for voltage-addressing an EL display pixel in an active matrix EL display device;

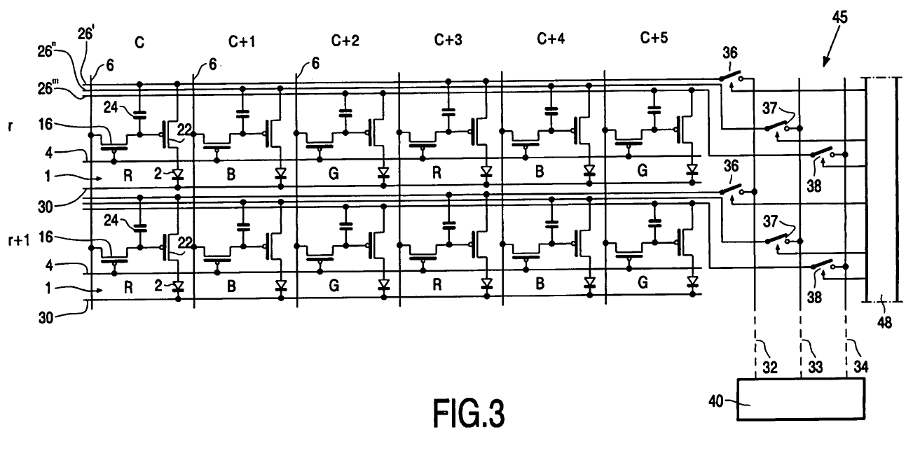

FIG. 3 shows schematically the circuit of several display pixels of two adjacent rows in a colour active matrix EL display device according to the invention; and

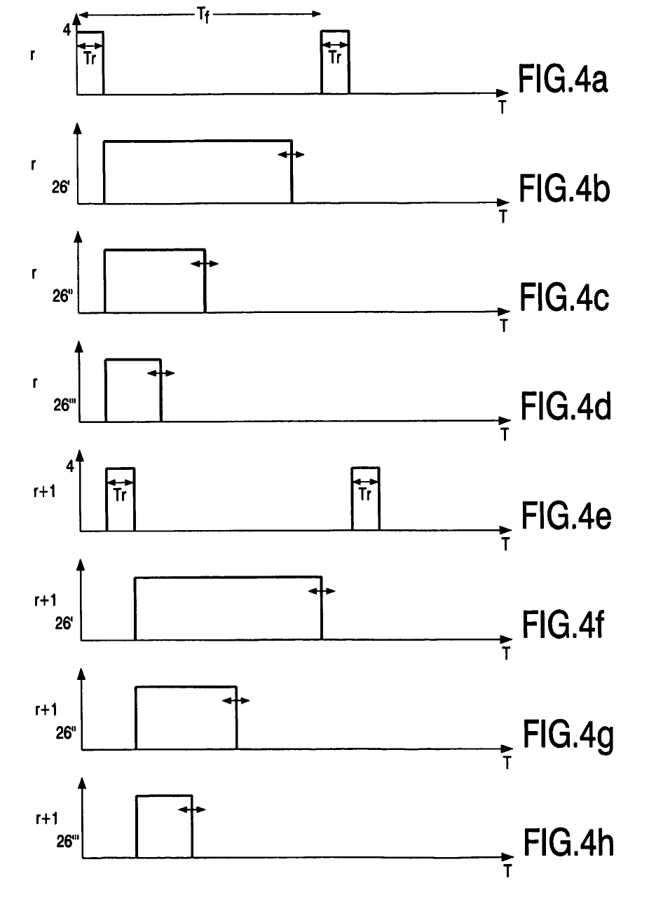

FIG. 4 shows example waveforms used in the driving of the display pixels of FIG. 3.

It should be noted that the Figures are merely schematic. The same reference numbers are used throughout the Figures to denote the same or similar parts.

Referring to FIG. 3, there is shown a representative part of a colour active matrix EL display device according to the invention comprising six display pixels 1 in adjacent columns C to C+5 in each of two adjacent rows, and r+1. Typically, the device comprises several hundred rows and several hundred columns of display pixels. Each of the pixels 1 is operable to produce light output of a respective colour, those in column C, C+3, etc, producing red light, those in column C+1, C+4, etc producing blue light, and those in columns C+2, C+5, etc producing green light, as signified by the labels R, G and B in FIG. 3. A group of three adjacent pixels in a row thus constitutes a colour triplet.

Each pixel 1 is of conventional form, similar to that of FIG. 2, including an EL display element 2 and associated driver circuitry comprising an address transistor 16, here in the form of a PMOS TFT, whose source and drain electrodes are connected between a column conductor 6 and the gate of a drive transistor 22, again in the form of a PMOS TFT, and whose gate is connected to a row conductor 4. A storage capacitor 24 is connected to the node between the transistors 16 and 22. The row conductor 4 is shared by all pixels in the same row and the column conductor 6 is shared by all pixels in the same column.

The cathodes of the EL display elements 2 of all pixels in a row are connected to a common potential line 30. In practice, this line is usually provided in the form of a continuous sheet electrode common to all pixels in the array.

The drive transistor 22 is connected between the anode of the EL element 2 and an associated power supply line 26 extending in the row direction, to which the other side of the storage capacitor 24 is also connected.

Unlike conventional pixel circuit arrangements in which all pixels in the same row share a single power supply line, three separate power lines 26′,26″ and 26′″ are used for each pixel row and to each of which pixels of a respective one colour are connected. Thus, in one row of pixels, the red emitting pixels in columns C and C+3 are associated with the power supply line 26′, the blue emitting pixels in columns C+1 and C+4 are associated with the power supply line 26″, and the green emitting pixels in columns C+2 and C+5 are associated with the power supply line 26′″. All other pixels in the same row are connected to respective ones of these power supply lines in similar fashion and a corresponding set of three power lines is provided for each of the other rows of pixels.

The pixels 1 operate generally in the same manner as described previously. Each row of pixels is addressed individually in turn in a respective row address period in which a row address (selection) pulse signal is applied to the relevant row conductor 4 to turn on the address transistors 16 of the pixels of that row. A data (brightness information) voltage signal applied to the individual column conductors 6 at this time is then passed by the transistor 16 to the gate of the drive transistor 22 and the storage capacitor 24 in each pixel in the row. At the termination of the row address pulse, the transistors 16 are turned off and the gates of the drive transistors 22 are held at levels corresponding to the data signal voltages by the storage capacitors 24 of the pixels. These stored voltages then determine the current passing through the respective EL display elements by their associated drive transistors 22 in a subsequent drive phase, and therefore the light output from the EL elements in that period. The drive transistors 22 operate in transconductance mode with the voltage between its gate and its source defining the current. Power to the power line supplying current to the EL display elements is applied following the row address period.

All pixel rows in the array are addressed in this manner in turn in a frame period, the frame period T_{f} being approximately equal to N×Tr where N is the number of pixel rows and Tr is the row address period, and are repeatedly addressed in subsequent frame periods.

This operation follows conventional practice and consequently has not been described in great detail. For further information regarding the operation pixel circuits reference is invited to the aforementioned publications such as EP-A-0717446, which also provides details of their construction.

In known display devices, the pixels are usually operable to emit light in accordance with a data voltage signal applied during a row address period for substantially the entire remaining frame period until they are addressed again, regardless of differences in the characteristics of the different colour LED display elements 2, such as their efficiencies of light production.

The provision of separate power supply lines for different colour pixels in the device of FIG. 3 enables greater control of differently coloured pixels of the device, and in particular compensation for differences in their operational characteristics, such as their respective efficiencies, by allowing the duty cycle of the different colour pixels to be varied independently.

The three power lines 26′, 26″ and 26′″ associated with a row of pixels are connected at one end of the row to respective power rails 32, 33 and 34 connected to a power supply 40 and extending along one side of the array through individually controllable switches 36, 37 and 38.

Predetermined and constant voltages are applied to the power rails by the power supply 40. The power rails 32, 33 and 34 are shared by the power lines 26′, 26″ and 26′″ of all pixel rows. The switches 36, 37 and 38 associated with all rows together constitute a switching arrangement 45 in which the switches 36, 37 and 38 effectively control the supply of power to their respective power lines 26′, 26″ and 26′″. Thus, the switches 36 control power supply to the red pixels, the switches 37 control power supply to the blue pixels and the switches 38 control power to the green pixels. Operation of the switches 36, 37 and 38 associated with one pixel row therefore enables the control of the respective operation of the three sets of different colour pixels in the row, thereby allowing the duty cycle of the three sets to be individual determined. The opening and closing of the switches 36, 37 and 38 in the switching arrangement 45 in this respect is controlled by a control circuit 48, which may for example be in the form of shift register circuit. The power rails and the switching arrangement 45, including the control circuit 48, may conveniently be integrated on the substrate carrying the pixel circuitry and the conductors 4, 6, 30 and 26 and fabricated simultaneously from common deposited layers, the switches 36, 37 and 38 and those in the control circuit 48 comprising, for example, polysilicon TFTs.

The switches 36, 37 and 38 may be arranged to connect the power lines to a reference potential, for example ground, when they are not connected to the power supply 40. The voltages applied to the power rails 32, 33 and 34 may be different and selected in accordance with the requirements of the differently-coloured EL elements with which they are associated. If, on the other hand, the same voltage is to be used for all pixels then only one power rail would be needed.

The operation of the switching arrangement 45 thus determines the proportion of the frame period for which each of the three sets of different colour pixels in a row are energised and by varying the timed operation of the switches the duty cycle for the different colour pixels can be varied individually. By varying the duty cycle of the three sets in this way the effects of their differing efficiencies, if present, can be compensated, and the colour composition of the display output from the array can be better controlled. A pixel energised to emit light for only a fraction of the full frame period will appear to have reduced brightness compared with that energised for the entire frame period. If a pixel is energised to produce a brightness output level Y, through the current control of its drive transistor 22 according to an applied data signal, and for I/X of the full frame period, then a viewer will perceive it as having an average brightness over time of Y/X. By adjusting the respective duty cycle of pixels using LED materials of different efficiencies it becomes possible to equalise and/or optimise the currents they consume. The less efficient pixel can be energised for the entire frame period following its addressing to keep its current consumption low and the more efficient pixel can be energised for only a fraction of that period such that it consumes a similar amount of current. Moreover, the ability to vary the duty cycles of different colour pixels enables the perceived brightnesses of the different colours to be individually controlled, as well as the overall brightness of the array output to be adjusted. Further, simple colour control for a display output can be effected without affecting gamma. In the case of the pixels being voltage programmed, as described above, then power to the power lines 26′, 26″ and 26′″ is preferably prevented by opening the associated switches 36, 37 and 38 during the relevant row address period and then closing the switches immediately after so as to energise the pixels. This will have the effect of preventing voltage drops which could otherwise occur along a power line during addressing from affecting the programmed voltage and leading to pixel output non-uniformities.

An example method of operating the display device using differing duty cycles for differently—coloured pixels will now be described with reference to FIG. 4 which illustrates schematically example waveforms applied to the six power lines 26′, 26″ and 26′″ present in the part of the pixel array shown in FIG. 3. The T axis represents time. FIGS. 4a and 4e illustrate the row address pulses applied to the row conductors 4 for rows r and r+1 respectively, these pulses being applied for the row address period Tr in an initial part of the frame period T_{f}. Thus the pixels I in row r are addressed in a respective row address period, with the relevant data signal voltages being programmed into the pixels, and immediately thereafter the pixels in row r+I are similarly addressed, followed by all succeeding pixel rows in turn in a respective frame period. FIGS. 4b, 4c and 4d illustrate the operation of the switches 36, 37 and 38 in supplying power to the power lines 26′, 26″ and 26′″ respectively of pixel row r, while FIGS. 4f, 4g, and 4h show the same kind of operation for the power lines 26′, 26″ and 26′″ associated with pixel row r+I. As can be seen in this example, the power supplied to the power lines 26′ associated with red pixels is longer in duration to the power supplied to the power lines 26″ associated with the blue pixels, which in turn is longer than the duration for which power is supplied to the power lines 26′″ associated with the green pixels. The arrows at the trailing edges of the waveforms indicate the variation possible in these durations. The duration of the energisation of any one power line may be decreased or increased to a maximum corresponding to approximately the termination of the frame period T_{f}.

As is also apparent, the switches 36, 37 and 38 are controlled row sequentially. Thus, the three switches 36, 37 and 38 associated with one row are operated at their selected times, through appropriate control by the control circuit 48, and this sequence of operation is repeated for the switches associated with the next row, delayed by one row address period.

Various modifications are possible, as will be appreciated by persons skilled in the art.

For example, although three separate power rails 32, 33 and 34 are provided, one for each set of power lines 26′, 26″ and 26″′, it may be possible to use a single power rail to which all power lines are connected through switches, although then it would not be possible to use different supply voltage levels for each of the three sets of different colour pixels.

Although a simple, voltage addressed, form of pixel circuit is used in the drive described embodiment, other known kinds of pixel circuits may be employed. For example, known pixel circuits using additional circuit elements for ageing compensation or for drive transistor threshold voltage compensation could be used. Moreover, current—addressed type pixel circuits, typically using a current mirror circuit for sampling a drive current during row addressing, may be employed. These alternative pixel circuits may use NMOS, PMOS or CMOS technologies.

From reading the present disclosure other modifications will be apparent to persons skilled in the art. Such modifications may involve other features which are already known in the field of active matrix EL display devices and component parts thereof and which may be used instead of or in addition to features already described herein.

1. A colour active matrix electroluminescent display device comprising a row and column array of display pixels (1), each pixel comprising an electroluminescent display element (2) and a drive transistor (22) for driving a current through the display element, the drive transistor and the display element being connected in series between a power line (26) for supplying or drawing a controllable current to or from the display element and a common potential line (30), wherein each row of display pixels (1) comprises different colour display pixels for producing different colour light outputs, wherein the display pixels of each colour in a row are associated with a respective and separate power line (26′, 26″, 26′″), and wherein the power supply to each power line is individually switchable (40, 45, 48) so as to control the duty cycle of the associated display pixels.

2. A display device according to claim 1, wherein the power lines (26′, 26″, 26′″) associated with the rows of pixels are connected to a power supply (40) through a switching arrangement (45) at one end of the rows.

3. A display device according to claim 2, wherein the power lines associated with a row of pixels are connected to at least one power supply rail through respective switches (36, 37, 38) of the switching arrangement (45).

4. A display device according to claim 3, wherein the number of power supply rails corresponds to the number of power lines associated with a row of pixels and the power supply rails are shared by all the rows of pixels.

5. A display device according to claim 3 or claim 4, wherein in each frame period (T_{f}) each row of pixels is arranged to be addressed in sequence in a respective row address period (Tᵣ) so as to store a drive signal for controlling the operation of the drive transistor (22) of the pixels.

6. A display device according to claim 5, wherein the switching arrangement (45) is operable to connect each of the power lines associated with a row of pixels to the power supply (40) for a predetermined period following addressing which determines the duty cycle of the display pixels associated with the power line, the power lines of each row of pixels being switched in similar manner in sequence.

7. A display device according to claim 6, wherein the power lines of a row are connected to the power supply (40) for a predetermined period that immediately follows the row address period (Tᵣ).

8. A display device according to any one of claims 5, 6 and 7, wherein each pixel includes a storage capacitor (24) for storing a gate voltage of the drive transistor (22) and an address transistor (16) for switching a data voltage to the gate of the drive transistor during the row address period, and wherein the switching arrangement (45) is operable to disconnect the power lines of a row of pixels from the power supply during the row address period.

9. A display device according to any one of claims 5, 6 or 7, wherein the pixels each include a current sampling circuit for sampling a drive current during the row address period and a storage capacitor for storing a gate—source voltage for the drive transistor corresponding to the sampled drive circuit and wherein the switching arrangement is operable to connect the power lines associated with a row of pixels to the power supply during the row address period.

10. A display device according to any one of claims 2 to 7 wherein the switching arrangement is fabricated on a substrate of the device carrying the display pixels and power lines.

11. A display device according to any one of the preceding claims, wherein each row of display pixels comprises red, green, and blue pixels, the different colour pixels being connected to respective power lines.
